(19) United States
(12) Patent Application Publication
(10) Pub. No.: US 2006/0124549 A1
(43) Pub. Date: Jun. 15, 2006

(54) Method and device for chromatography comprising a concentration step

(76) Inventors: Michel Bailly, Nancy (FR); Roger-Marc Nicoud, Lay-St-Christophe (FR); Philippe Adam, Maxeville (FR); Olivier Ludemann-Hombourger, Chavigny (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/533,419

(22) PCT Filed: Oct. 29, 2003
(86) PCT No.: PCT/FR03/03227

§ 371 Date: Nov. 28, 2005

(30) Foreign Application Priority Data
Oct. 29, 2002 (FR) 02/13536

(51) Int. Cl. B01D 15/08

(52) U.S. Cl. 210/656; 210/659; 210/198.2

(57) ABSTRACT

The invention concerns a method for multiple-column chromatographic spearation producing at least two fractions, comprsing the following steps: in output of the extract, zone 1, or the raffinate zone, zone III: (i) drawing at least part of the output flow of said zone; (ii) concentrationg said part; and (iii) re-injecting at least partly said concentrated part. The invention also concerns a device for implementing said method.

The present invention relates to a process and apparatus for chromatography, allowing improved productivity.

Preparative chromatography is employed as a method for purifying mixtures, in particular pharmaceutical mixtures. For example, present-day chromatography methods can be schematized as the separation of two or several “components” of a feed or mixture to be purified. Using a solvent and a chromatography bed, two or more fractions are obtained. In one particular mode, two fractions are obtained the first having a first “component” and the other a second “component”. One of the two, and more rarely both, component(s) is/are the one(s) looked for.

Several chromatography techniques on an industrial scale are known, including the multi-column SMB (simulated moving bed) and Varicol® types.

The SMB process calls on the use of simulation of counter-flow of the bed and fluid, notably by application of the technology initially developed by UOP (U.S. Pat. Nos. 2,985,589, 3,291,726 and 3,266,604). Thus, the points of introduction of the feed and eluting agent are periodically displaced, as are the points at which the extract and raffinate are drawn off. Displacement is synchronous, meaning that the various feed and draw-off points are displaced simultaneously.

The so-called Varicol® process which is fundamentally different from SMB, employs asynchronous displacement of the various feed and draw-off points. We can mention that this apparatus and the process associated therewith are notably disclosed in International Application WO-A-0025885. That document discloses a separation method for at least one component from a mixture containing it, in apparatus having a set of chromatography columns or sections of chromatography columns containing an absorbent, arranged in series and in a loop, the loop having at least one feed injection point, a point for drawing-off the raffinate, a point for injecting an eluting agent and a point for drawing-off the extract, in which a chromatography zone is determined between an injection and draw-off point or vice-versa, the process being characterised in that at the end of a given time period, all the injection and draw-off points are shifted by the same number of columns or column sections, advantageously by one column or columns section, in a given direction defined with respect to that of the flow of a main fluid circulating through the loop and in that, during said period, the various injection and draw-off points are shifted at different points in time whereby the length of the zones defined by said different points is variable.

Both the above techniques call on the use of a multi-column process the performance of which is a limiting factor as regards a process that is competitive with conventional purification techniques (for example, crystallization, extraction, etc).

Further, the productivity of a chromatography process is generally limited by the capacity of the chromatographic carrier (number of absorption sites on the carrier). The majority of preparative chromatographic applications involve the use of injection conditions for which the effects of overload are felt: the amount injected is maximized up to the point where the effects of saturation of the carrier limit separation of the species injected.

There is consequently a need to improve the performance of multi-column systems, either through greater productivity for identical purity of the purified products or through higher purity of the products with an identical injected amount.

U.S. Pat. No. 5,387,347 discloses a multi-column process implementing a concentration step. This step involves drawing off part of the liquid circulating corresponding to at least twice the feed throughput. This drawing off (without reinjection), is implemented immediately prior to injecting the feed.

There is nothing in that document teaching or suggesting the present invention.

The invention thus provides a multi-column chromatography separation process producing at least two fractions, comprising the following steps, at the outlet from the extract zone, zone I, or raffinate zone, zone III: (i) at least a part of the outlet flow rate from said zone is drawn off; (ii) said part is concentrated; and (iii) the concentrated part is at least partially reinjected.

According to one embodiment, the totality of the outlet flow rate from said zone is drawn off.

According to another embodiment, the concentrated part is partially reinjected.

According to another embodiment, between 50 and 99.5% of the concentrated part, preferably between 70 and 98%, is reinjected.

Alternatively, the concentrated part is totally reinjected.

According to one embodiment, a concentration factor F is comprised between 1.1 and 10, preferably between 1.25 and 5.

According to another embodiment, drawing-off is performed downstream of the extract zone, zone I.

In one embodiment, the chromatography separation is of the SMB type.

In another embodiment, the chromatography separation is of the Varicol type.

There is also provided chromatography apparatus comprising: (i) a plurality of separation columns; (ii) a drawing off point at the outlet from said columns for drawing off at least a part of the outlet flow rate from a column; a device for concentrating said part; (iii)a reinjection point immediately after the drawing off point for reinjecting at least partially the concentrated part.

The apparatus preferably comprises a valve between the drawing-off and reinjection points.

In one embodiment, the apparatus comprises partial collection of the concentrated part.

According to another embodiment, the concentration device is an evaporator.

In one embodiment, the plurality of separation columns is of the SMB type.

In an alternative embodiment, the plurality of separation columns is of the Varicol type.

The apparatus is adapted for carrying out the process of the invention.

Further characteristics and advantages of the invention will now be described in detail below with reference to the attached drawings in which:

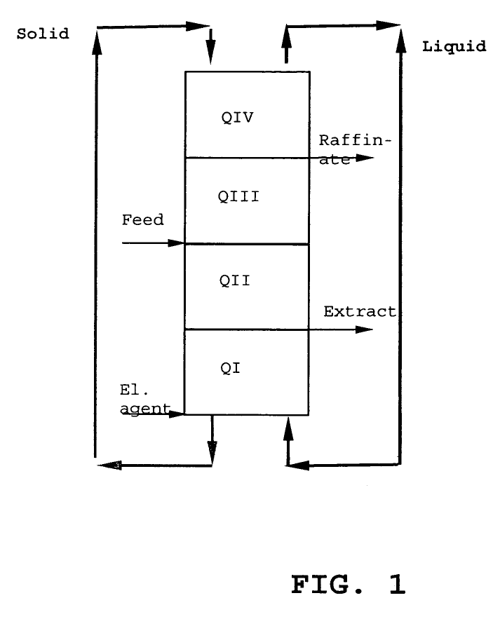

FIG. 1 is a diagrammatic view of an actual continuous counter-current chromatographic process: the “true moving bed”,

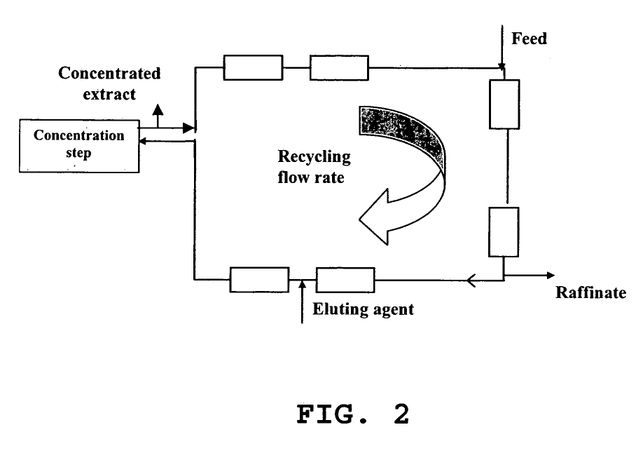

FIG. 2 is a diagrammatic view of apparatus of the invention.

With reference to FIG. 1 a conventional 4-zone counter-flow process, i.e. the “true moving bed” is described. According to that principle, the solids rotate continuously in a closed loop between fixed points for introducing the feed, eluting agent and for drawing off the extract and raffinate. The following four zones are then distinguished:
zone 1: everything located between the eluting agent and extract lines;
zone 2: everything located between the extract and feed lines;
zone 3: everything located between the feed and raffinate lines; and

Zone 4: everything located between the raffinate and eluting agent lines.

The solid flow rate is constant throughout the system but, in view of the inlet/outlet flow rates, the liquid flow rate varies depending on the zone: QI, QII, QIII and QIV being the respective flow rates in the zones I, II, III and IV.

The principle of the simulated moving bed, reviewed briefly above, operates by shifting the inlet and outlet points at fixed intervals in a multi-column system. This process is defined by the following main characteristics:

1. Zones defined by the position of the inlet/outlet lines;

2. A fixed number of columns per zone;

3. Fixed length zones; and

4. Synchronized displacement of all the inlet/outlet lines.

(The characteristics 2, 3 and 4 are due to the fact that the simulated moving bed simulates the behavior of the “true” moving bed).

In the so-called Varicol® process, the basic idea is to modify the true moving bed discussed above with an aim to allowing variation over time of zone length.

Contrary to the true moving bed, zone lengths are no longer fixed but vary over time. In one embodiment, these variations can be periodic so that the system comes back to its original position after a given time. (Due to variation in zone length, unlike the “true” moving bed, this system is not stationary and solid speed is not constant with respect to the inlet/outlet lines).

When a Varicol® process is implemented, zone lengths oscillate continuously by one column, the increase in the length of one zone been compensated for by decrease in that of the next one. For other implementations, increase in length of one zone can for example be compensated for by a decrease in the opposite zone, but other implementations are possible.

The differences between the Varicol® system and the simulated moving bed process are then:

1. Zone lengths are not constant;

2. Column number per zone is not constant over time;

3. The inlet/outlet lines are not displaced simultaneously;

4. Solid flow rate simulated by the Varicol® process is not constant with respect to the inlet/outlet lines.

As explained, a preferred implementation of the Varicol process is periodic (period Δt), so that after a given time, this system returns to its original configuration. During this time, the number of columns in each zone has been varied, and for commodity purposes, it can be useful to define a mean number of columns per zone:

<Nb1>: mean number of columns contained in zone 1 during one period

<Nb2>: mean number of columns contained in zone 2 during one period

<Nb3>: mean number of columns contained in zone 3 during one period

<Nb4>: mean number of columns contained in zone 4 during one period.

Similarly, a simulated moving bed system can be represented by:
SMB: Nb1/Nb2/Nb3/Nb4

The Varicol® system can be represented by:
VARICOL® <Nb1/<Nb2>/<Nb3>/<Nb4>

(Nevertheless, whereas the number of columns per zone has a real meaning for SMB systems, the mean numbers (generally not whole numbers) have no technical meaning and are simply employed for commodity purposes for the Varicol process).

With reference to FIG. 2, apparatus comprising six columns is described. Zones I, II, III and IV are defined between the various points of injection and drawing-off, as indicated above. The apparatus according to the invention comprises a break in the column loop. One could also only have a partial loop break. This can be typically managed using a valve located between the draw-off and injection points.

The flow collected at the outlet from the column located upstream of the point where the loop is broken is continuously or discontinuously concentrated, for example using an evaporation process. The concentrated solution is then partially (for example between 50 and 99.5%, preferably 70-98%) or totally reinjected to the inlet to the column downstream of the break point. This break point is regularly switched in order to preserve the same position relative to the zones of the process. The reinjection rate is defined with respect to the fractions. The break in the loop with a view to performing concentration can also be applied to multi-column processes already having a break in the loop at any point whatsoever.

According to the method of concentration used, the flow collected, concentrated and reinjected may necessitate readjustment of the composition in eluting agent (for example, if the latter is not a pure solvent).

In the case of FIG. 2, the break is downstream of zone I. This embodiment is advantageous notably in the particular case of a Langmuir type absorption isotherm having a competitive saturation effect for the number of sites on the chromatographic carrier. The flow collected is then concentrated and partially reinjected into the column downstream (inlet to Zone II). That fraction of the concentrated flow which is not reinjected is collected: it corresponds to concentrated extract (most retained product purified).

In the case illustrated (break in loop downstream of zone I), the new process is characterised by the concentrated flow concentration rate F:
F=C_{extconc}/C_{outZoneI} (C_{extconc} and C_{outZoneI} being the concentrations of the concentrated extract collected and of the outlet flow from zone I, respectively). (C_{extconc} is also the concentration of the injection flow to zone II).
the eluting agent, feed and raffinate flow rates: Qₑₗᵤ, Q_{feed} and Q_{raf}, respectively (the extract flow rate in a conventional process would be Qₑₓₜ)
the input flow rate to zone II, Q_{II}.
the outlet flow rate from zone I, Q_{I}.

The concentrated extract flow rate collected (Q_{extconc}) is now given by the material balance on the process, as follows:
Q_{extconc}=(Qₑₗᵤ+Q_{feed}−Q_{raf})/F+Q_{II}*(1/F−1)
(or also Q_{extconc}=Q_{I}/F−Q_{II})

The reinjection rate T indicated above is given by:
T=(Q_{II}*F)/Q_{I}
(or also T=1−(Q_{extconc}*F)/Q_{I})q. This factor F can vary between 1.1 and 10, preferably between 1.25 and 5.

The disclosed process allows separation of binary mixtures. It is consequently particularly adapted to separation of enantiomers or to any other application designed to separate a mixture of two species.

The process can also be applied to mixtures of more than two species. The mixture is then separated into two fractions at each step in the new process. Depending on requirements, several purification steps, by a new process or another process, can be implemented.

The process according to the invention is generally continuous; the flow rates given above are constant over time.

In certain cases, one can also be led to reduce or stop, over a fraction of the period, the extract or raffinate flow rate while simultaneously decreasing the eluting agent flow rate. This can be achieved since:
as the lines for injecting eluting agent and drawing-off extract are located at the same point (column number in Zone I temporarily zero, which can happen when the number of columns is small and the offset of feed and draw-off lines is performed asynchronously, in the case of the Varicol process): the collection of extract can then be reduced or stopped and the eluting agent flow rate diminished by the same amount;
the line for injecting eluting agent and drawing off raffinate are located at the same point (number of columns in zone IV temporally 0) : raffinate collection can be reduced or stopped and the flow rate of eluting agent decreased by the same amount.

This allows, in certain cases, the dilution of what is collected to be decreased thereby reducing eluting agent consumption for the process (amount of solvent employed for purifying a given amount of product).

Conventionally, the eluting agent employed in the process can be a liquid, a super-or sub-critical fluid or a compressed gas.

The present process applies to any type of chromatography process, including those that couple reaction and separation. An example of such a process is disclosed in United States Patent Application 2001/0031903A1.

The following examples illustrate the present invention without however limiting the scope thereof.

### EXAMPLE 1

The separation of the enantiomers of Ketoprofene was performed firstly using SMB and secondly using the process of the invention. We show that the new process makes it possible either to obtain higher purity at constant productivity, or to increase productivity at constant purity.

Separation is performed on a continuous multi-column pilot employing six 1×10 cm diam. columns filled with 20 μm ChiralCel OJ (Daicel). The eluting agent was a hexane/IPA/acetic acid mixture 90/10/0.5% v/v.

Racemic solubility in the eluting agent was around 25 g/l at ambient temperature.

Separation took place at 25° C., optical purity of 99% was aimed at for the extract and raffinate.

Column distribution, both in SMB and in the process of the invention, was as follows:
one column in zone I,
two columns in zone II,
two columns in zone III,
one column in zone IV.

Performance Obtained with SMB

The conditions are given in the table below.

| Feed conc | Q_{feed} | Qₑₗᵤ | Qₑₓₜ | Q_{raf} | |
|---|---|---|---|---|---|
| (g/l) | (ml/min) | (ml/min) | (ml/min) | (ml/min) | Q_{I} (ml/min) |
| 25 | 0.74 | 23.81 | 18.10 | 6.44 | 38.54 |

The switch-over period was 1.07 minutes.

Optical purities obtained were 99.0% for the extract and 95.3% for the raffinate with a productivity of 26.6 g racemic injected per day.

Performance Obtained with the Process of the Invention

Case A

The conditions are given in the table below (the recycling flow rate is not indicated since the loop is open).

| Feed conc | Q_{feed} | Qₑₗᵤ | | Q_{raf} | Q_{II} |
|---|---|---|---|---|---|
| (g/l) | (ml/min) | (ml/min) | F | (ml/min) | (ml/min) |
| 25 | 0.74 | 23.80 | 1.90 | 4.49 | 18.50 |

The switch-over period was 1.07 minutes.

Optical purities obtained were 99.4% for the extract and 98.4% for the raffinate for a productivity of 26.6 g racemic injected per day. We can note an improvement both in extract purity and raffinate purity compared to the optimized SMB process for the same productivity.

Case B

The conditions are given in the table below.

| Feed conc | Q_{feed} | Qₑₗᵤ | | Q_{raf} | Q_{II} |
|---|---|---|---|---|---|
| (g/l) | (ml/min) | (ml/min) | F | (ml/min) | (ml/min) |
| 25 | 1.13 | 23.79 | 1.89 | 3.77 | 19.26 |

The switch-over period was 0.95 minutes.

Optical purities obtained were 99.1% for the extract and 95.50% for the raffinate for a productivity of 40.7 g racemic injected per day. We can note a 50% increase in productivity compared to the SMB process, accompanied by a slight improvement in raffinate purity.

The table below summarizes the flow rates in the various zones.

| Flow rate | SMB | Case A | Case B |
|---|---|---|---|
| Q_{I} | 38.54 | 38.54 | 40.41 |
| Q_{II} | 20.44 | 18.50 | 19.26 |
| Q_{III} | 21.18 | 19.24 | 20.39 |
| Q_{IV} | 14.74 | 14.75 | 16.62 |
| Q_{extconc} | | 1.77 | 2.13 |
| T | | 91 | 90 |

1. A multi-column chromatography separation process producing at least two fractions, comprising the following steps, at the outlet from the extract zone, zone I, or raffinate zone, zone III:
(i) at least a part of the outlet flow rate from said zone is drawn off;
(ii) said part is concentrated; and
(iii) the concentrated part is at least partially reinjected.

2. The process according to claim 1, in which the totality of the outlet flow rate from said zone is drawn off.

3. The process according to claim 1, in which the concentrated part is partially reinjected.

4. The process according to claim 3, in which between 50 and 99.5% of the concentrated part, preferably between 70 and 98%, is reinjected.

5. The process according to claim 1, in which the concentrated part is totally reinjected.

6. The process according to claim 1, in which a concentration factor F is comprised between 1.1 and 10, preferably between 1.25 and 5.

7. The process according to claim 1, in which drawing-off is performed downstream of the extract zone, zone I.

8. The process according to claim 1, characterised in that the chromatography separation is of the SMB type.

9. The process according to claim 1, characterised in that the chromatography separation is of the Varicol type.

10. Chromatography apparatus comprising:
i. a plurality of separation columns;
II. a drawing-off point at the outlet from said columns for drawing off at least a part of the outlet flow rate from a column;
III. a device for concentration said part;
IV. a reinjection point immediately after the drawing-off point for reinjecting at least partially the concentrated part.

11. The apparatus according to claim 10, comprising a valve between the drawing-off and reinjection points.

12. The apparatus according to claim 10, comprising partial collection of the concentrated part.

13. The apparatus according to claim 10, in which the concentration device is an evaporator.

14. The apparatus according to claim 10, characterised in that the plurality of separation columns is of the SMB type.

15. The apparatus according to claim 10, characterised in that the plurality of separation columns is of the Varicol type.

16. (canceled)
